(19) United States
(12) Patent Application Publication
(10) Pub. No.: US 2005/0264185 A1
(43) Pub. Date: Dec. 1, 2005

(54) Method of producing organic light-emitting surface elements and an organic light-emitting surface element

(75) Inventor: Uwe Hoffmann, Alzenau (DE)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Applied Films GmbH & Co. KG

(21) Appl. No.: 11/128,469

(22) Filed: May 13, 2005

(30) Foreign Application Priority Data
May 25, 2004 (DE) 10 2004 025 578.4

(51) Int. Cl. H05B 33/00

(52) U.S. Cl. 313/504

(57) ABSTRACT

A method of producing organic light-emitting surface elements (OLEDs), wherein first a first electrode, an organic functional layer and a second electrode are deposited successively on a substrate. The method is used to produce the second electrode in the form of an interference layer system having n metallic sublayers and n+1 oxidic sublayers. The layers are disposed in pairs that each enclose a metallic sublayer therebetween, with n being an integer and ≧1. This method has the advantage of a very high light transmission for designing top-emitter OLEDs that cover a large surface area, while at the same time keeping the sheet resistance of the junction electrode located away from the substrate very low, thereby enabling operation at less than 10 V.

### CROSS-REFERENCE TO RELATED APPLICATION

This application claims priority to German Patent Application No. 10 2004 025 578.4, filed on May 25, 2004, entitled A METHOD OF PRODUCING ORGANIC LIGHT-EMITTING SURFACE ELEMENTS AND AN ORGANIC LIGHT-EMITTING SURFACE ELEMENT.

### FIELD OF THE INVENTION

The invention relates to a method of producing organic light-emitting surface elements. The invention further relates to organic light-emitting surface elements that can be produced particularly using the aforementioned method.

### BACKGROUND OF THE INVENTION

Such surface elements are also known as organic light-emitting diodes (hereinafter abbreviated to OLEDs). Functional layer systems or multilayers that are based on organic materials and whose production sets certain limits, particularly in relation to temperature, are an essential component of such OLEDs. The basic structure of OLEDs is composed of a rigid or flexible substrate (glass, plastic, wafer, printed circuit board, film, etc.) on which a usually transparent junction electrode (front electrode) is first deposited before the actual light-emitting layer system is deposited. A junction electrode (back electrode) is in turn deposited on this layer system. Light is produced as soon as a voltage is applied between both junction electrodes and a current flows therebetween.

The person skilled in the art is familiar not only with OLEDs having non-transparent back electrodes (e.g., U.S. Pat. No. 4,539,507), also termed “bottom emitters” because they emit the light through the transparent substrate, but also with OLEDs having transparent back electrodes (e.g., U.S. Pat. Nos. 5,703,436 and 5,707,745) that can be constructed on non-transparent substrates, in which case they are termed “top emitters”. In the latter instance, the OLEDs may, however, be completely transparent, too, even if the substrate and functional layer system are transparent at least in their OFF state.

Because OLEDs convert current into light, the two electrodes must be able to conduct considerable currents when the elements cover a large surface area. Typical current densities are as much as 50 mA/cm². Conflicts do, however, arise between the demands of light transparency and those of the junction electrodes' larger layer thicknesses that usually accompany lower sheet resistances. It is immediately understood that a comparatively thicker (metallic or conductive oxidic) electrode simultaneously has a lower sheet resistance and a lower light transmission.

The junction electrodes are fed voltage either via comb electrodes (which may, for example, be thin metallic conducting tracks that are spread over the junction electrode's surface) or more often via bus bars deposited on the edge of the junction electrodes. The advantage of the latter configuration is that the lateral bus bars can be optically coated within the edge region and are invisible by lock-through through the light-emitting element.

Transparent indium tin oxide (ITO) front electrodes located close to the substrate are very common in display applications. Such electrodes are, for example, 150 nm thick and have a sheet resistance of approx. 10 Ω/square unit (thereby obtaining a specific resistance of 150 μΩ/cm). This results in voltage drop of 12.5 V from one edge of the display to its center when a 2.5 A current is applied across the junction electrode contacted on both sides via bus bars. However, this voltage difference is incompatible with the intended 10 V operating voltage.

Moreover, such low sheet resistances can only be achieved if the electrode layers are deposited at substrate temperatures of 200° C. and higher (e.g., by magnetic-field-assisted cathode sputtering). The above deposition process renders such electrodes uninteresting as OLED back electrodes located away from the substrate, because the organic layers would decompose at such high temperatures.

Although junction electrodes composed of pure metallic layers (such as gold or silver) are conceivable, too, they are, in turn, sufficiently transparent only if there are very low thicknesses and relatively high sheet resistances (as regards gold, see X. Zhou et al., Appl. Phys. Lett. 81(2002), 922).

The person skilled in the art is familiar with the use of optically highly transparent layer systems on glass or plastic substrates as thermal insulation layers that reflect infrared radiation. Such layer systems are also known as interference layer systems, because they are composed of specific sequences of dielectric (oxide, oxynitride, etc.) and metallic layers, each with a different refractive index. The dielectric layers have a reflection-reducing effect on the metallic layers, thus reducing their per se high light reflection. When there is a very low thickness (in the range of a few nanometers) and a very low ohmic sheet resistance (far below 10 Ω/square unit) at the same time, such layer systems are therefore characterized by a very high light transmission of more than 75%.

These layer systems have, furthermore, been described (DE 197 33 053 A1, DE 199 48 839 A1, DE 100 39 412 A1) as electrodes located close to the substrate and intended for large-surface displays (e.g., flat-screen monitors). Additionally, more than one metal layer can be provided and each metal layer is embedded between two dielectric layers respectively. ITO is suitable for oxidic layers and silver for metal layer(s). However, such electrodes have so far not been used in OLED display applications. On the one hand, the conductivities that can be achieved with conventional ITO electrodes (while ensuring a simultaneously high transparency) are totally sufficient for LCDs. On the other hand, the layers, after being deposited, are nearly always structured by wet-chemical means (subdivided into segments), which is hard to achieve in multilayer systems because the oxide and metal layers behave differently during etching and thus no extremely clean barriers can be incorporated. The use of laser beams to structure such layer systems is, however, known as well.

### SUMMARY OF THE INVENTION

An object of the present invention is to enable the aforementioned type of organic light-emitting surface element to also exhibit high light transmission on the side located away from the substrate, whereby the electrode located away from the substrate is to maintain as low a sheet resistance as possible and its deposition is to be made possible at temperatures compatible with the organic functional layers.

In accordance with one aspect of the invention, the above-described object is solved in that after the functional layers have been deposited, an interference layer system comprising at least one metallic layer and at least two oxidic layers that enclose the metallic layer therebetween is deposited on the surface element. Such oxidic layers are also known collectively as “transparent conductive oxides”, abbreviated to TCO. Indium tin oxide (ITO) is just one of several possible materials, though it is also the most commonly used in this application. Indium cerium oxide (ICO) can be used here, too. Additionally, TCO layers can be made from tin oxide and zinc oxide, whereby metallic doping may enhance or produce the conductivity.

The aforementioned layer systems are also termed “IMI” layers, with “I” standing for ITO and “M” for metallic layer. If two (or more) metallic layers are each provided with an intermediate TCO layer, they may be termed IMIMI layers. This term does not, however, exclude the use of other TCO materials.

Although, as mentioned, such layer systems are known per se, their use as a top electrode located away from the substrate has not presented itself to the skilled person. These systems cannot, for example, be deposited completely and then structured (etched locally) in their entirety; instead, they must be etched layer by layer. Furthermore, the view had previously been taken that the organic light-emitting layers exhibited too little thermal stability as to tolerate the deposition of this manner of layer system. Normally, individual ITO layers are deposited on substrates at relatively high temperatures in order for the layer to exhibit as low a sheet resistance as possible. In addition, ITO can be deposited only by means of sputtering rather than by vapor-deposition, with the sputtered particles impacting the substrate surface with considerable energy (up to 10 eV). During conventional vapor-deposition processes, the impacting particles have much lower energies of 0.3 eV at maximum, which had no adverse effect on organic layers.

Above all, such transparent junction electrodes ideally serve as covering layers for top-emitter type OLEDs (passive matrix, active matrix, pixel displays, luminous symbols) and for emitting surfaces (lamps, linings, wallpaper, etc.) in which the emitted light need not or is not intended to radiate through the substrate itself.

It is evident that when the interference layer system is deposited, the process temperatures in the substrate must not exceed those values that the organic functional layers tolerate without detrimental effect. The temperature limit is approx. 80° C. and can be adhered to when the junction electrode located away from the substrate is deposited by means of sputtering. If necessary, cooling may be provided for the substrate and those layers already deposited thereon.

Such a junction electrode located away from the substrate does not have to be structured or subdivided after it has been deposited; rather, during “display” mode, it serves merely as a common electrode for all the display pixels. The pixels are triggered individually or “pixel by pixel” in that the electrode located close to the substrate and under the pixels is subdivided (structured). In this case, each pixel can be activated via control or bus lines located on the substrate and via associated switching electronics. Moreover, the pixels are separated from one another by means of isolating fillers, with the result that adjacent pixels are not triggered.

In the “emitting surface” application, none of the junction electrodes need be subdivided, because it is important to maintain as homogeneous a power supply as possible over the entire area.

The junction electrode located away from the substrate and according to the invention is characterized by a high Haacke's Q factor, i.e. by a good ratio between optical light transmission (in percent) and sheet resistance (in Ω/square unit).

Because it is unnecessary to structure the electrode located away from the substrate, the poor degree to which the layer system can be etched is no longer a disadvantage. The deposition or sputtering process for the transparent conductive oxide can be set up such that the substrates are cold when coating begins, and a low sputtering rate is used initially. This rate can be increased as the layer gets thicker. The TCO layer obtained in this manner (e.g., an ITO or ICO layer) may then exhibit a somewhat higher sheet resistance, though, within the overall layer system, the sheet resistance is defined mainly by the metallic layer's low resistance.

Having been deposited on the organic layer system, the initial TCO layer protects the system during subsequent layer deposition, which makes further process implementation relatively simple.

The deposition of a sandwich composed of several metallic layers, each with an intermediate TCO layer, can reduce sheet resistance even more overall. The optical interference action of the TCO layers causes such sandwiched-layer systems to retain a high degree of transparency to visible light. If the metallic layer were too thick, however, it would immediately become opaque.

The TCO layers can be sputtered from metal targets in a preferably reactive manner (using an oxygen component in the working atmosphere); but the layers can also be deposited from oxidic targets in an inert (argon) atmosphere. In contrast, the metallic layers are, of course, deposited in an inert (argon) atmosphere.

Further details and advantages of the invention's subject matter are evident from the illustration of an exemplary embodiment and from their detailed description here below.

### BRIEF DESCRIPTION OF THE DRAWINGS

The figures are schematic diagrams in which:

FIG. 1 shows a view of an active matrix OLED in “display” mode, emphasizing a single pixel that can be triggered individually;

FIG. 2 shows a cross section of the OLED having the structure according to the invention.

### DETAILED DESCRIPTION OF PREFERRED EMBODIMENT

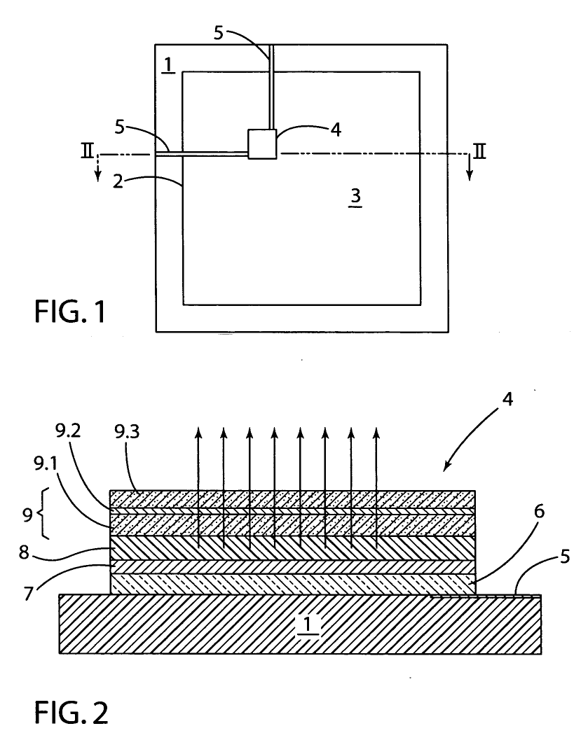

With reference to FIGS. 1 and 2, an active matrix OLED is constructed as a top-emitter display on a substrate 1; edge 2 of emitting surface 3, which can be activated in its entirety to emit light, keeps, circumferentially, a slight distance from the edge of substrate 1. Emitting surface 3 emphasizes an individual pixel 4 together with bus lines 5 leading thereto. Pixel 4 is individually triggered by these lines. The entirety of emitting surface 3 is covered with further pixels not shown here.

FIG. 2 illustrates the layer structure upon which this active matrix OLED is based. In accordance with the invention, the OLED is provided with a transparent IMI top electrode. Starting from substrate 1, there follow bus lines 5 and switching electronics 6, followed by a lower grid-like electrode 7 located away from the substrate. Substrate 1 and grid-like electrode 7 may be transparent to visible light (bottom emitter) or opaque in this respect (for a top emitter). On electrode 7, composed, for example of ITO, a metal or a multilayer system of the manner described in the aforementioned prior art, there is deposited a light-emitting functional layer 8 composed of organic materials. This functional layer can in turn comprise a plurality of sublayers—not shown here. Such organic light-emitting functional layers have often been described in the literature, thus making it unnecessary to discuss them in more detail here.

A highly transparent junction electrode located away from the substrate and designed as an interference layer system—designated in its entirety as 9—is deposited over the emitting layer. The system comprises a first conductive oxidic sublayer 9.1 deposited directly on functional layer 8. The system further comprises a metallic, electrically readily conductive sublayer 9.2, and a second conductive oxidic sublayer 9.3.

The preferred light-emitting direction of functional layer 8 and the passage of the light rays through junction electrode 9 located away from the substrate (when used as a top emitter) is marked by a group of arrows.

The interference layer system's sublayers are preferably sputtered in a vacuum by means of d.c. cathode sputtering, if necessary, assisted by magnetic fields (magnetron sputtering). This method has, in itself, long been known and has often been described. In relation to specific sputtering parameters (working gas, oxygen partial pressures, layer thicknesses, sputtering rates), attention can therefore be drawn to the pertinent prior art, especially DE 199 48 839 A1.

In a preferred embodiment, the two conductive oxide layers are composed of ITO and the metallic layer is composed of silver, if need be, with a small amount of copper of roughly 10 percent by weight in order to increase their hardness and hence mechanical resistance.

Instead of ITO, indium cerium oxide (ICO) can be deposited as an oxidic conductive layer, too.

Electrode 7 located close to the substrate can likewise be composed of ITO. It does not have to be transparent and is for example 150 nm thick; functional layer 8 is 50 to 500 nm, preferably 150 nm thick. The thickness of sublayer 9.1 ranges from 30 to 70 nm, metallic sublayer 9.2 is 5 to 20 nm thick and oxidic sublayer 9.3 is 30 to 70 nm thick. The aforementioned thickness ratios have been approximately taken into account in FIG. 2, although, of course, it cannot be to scale.

The light transmission of junction electrode 9 is 80 percent (toward air) and more. Overall, its sheet resistance is less than 4 Ω/square unit, with particular preference on its being less than 3 Ω/square unit, while 2.5 Ω/square unit is ideal. A surface element equipped in this manner is thereby ideal as a top emitter for large-area applications of the type mentioned above. These applications can, moreover, be operated at the low voltages of less than 10 V that are preferably to be applied in such instances.

1. A method of producing organic light-emitting surface elements (OLEDs), comprising:
successively depositing on a substrate a first electrode, an organic functional layer and a second electrode; wherein
the second electrode is produced in the form of a transparent interference layer system having n metallic sublayers and n+1 transparent conductive oxidic sublayers, the sublayers being disposed in pairs that each enclose a metallic sublayer therebetween, with integral n being ≧1.

2. A method according to claim 1, wherein the sublayers are deposited utilizing a sputtering process.

3. A method according to claim 1, wherein the oxidic sublayers are sputtered from substantially metallic cathodes in a reactive working atmosphere.

4. A method according to claim 1, wherein the oxidic sublayers are sputtered from oxidic cathodes in a substantially inert working atmosphere.

5. A method according to claim 1, wherein the oxidic sublayers are deposited as indium tin oxide or as indium cerium oxide.

6. A method according to claim 1, wherein the metallic sublayer/sublayers is/are deposited from silver.

7. A method according to claim 1, wherein the metallic sublayer/sublayers is/are deposited from an alloy of silver and at least one other metal that is not silver, in an inert working atmosphere.

8. A method according to claim 1, wherein the metallic sublayer/sublayers is/are deposited from an alloy of silver and copper, in an inert working atmosphere.

9. A method according to claim 1, wherein the electrode located away from the substrate is deposited as a layer system having a sheet resistance of less than 3 Ω/square unit, preferably less than 2.5 Ω/square unit, and the electrode's light transmission for visible light is higher than 80%.

10. A method according to claim 1, wherein a substrate temperature of 80° C. is not exceeded during deposition of the electrode located away from the substrate.

11. A method according to claim 10, wherein the temperature is limited by cooling the substrate and those layers already deposited thereon.

12. A method according to claim 1, wherein the electrode located away from the substrate has a total thickness of preferably 150 nm, and the oxidic sublayers are deposited with thicknesses between 30 and 70 nm and the metallic sublayer/sublayers is/are deposited with thicknesses between 5 and 20 nm.

13. A light-emitting surface element, comprising:
a substrate;
an electrode located proximate the substrate;
an organic, activatable functional layer suitable for emitting light; and
a transparent electrode located away from the substrate, wherein:
the transparent electrode located away from the substrate comprises an interference layer system having n metallic sublayers and n+1 transparent conductive oxidic sublayers, the sublayers being disposed in pairs that each enclose a metallic sublayer therebetween, with n being integer and ≧1.

14. A surface element according to claim 13, wherein the substrate is composed of a material selected from the group consisting of glass, a plastic film or a wafer.

15. A surface element according to claim 13, wherein the junction electrode located away from the substrate comprises at least two oxidic sublayers composed of indium tin oxide or indium cerium oxide, and at least one metallic sublayer including silver.

16. A surface element according to claim 13, wherein the functional layer is subdivided into a plurality of pixels to produce a top-emitter display that can be activated pixel by pixel, the junction electrode located away from the substrate serving as a common collector for the pixels.

17. A surface element according to claim 13, wherein the functional layer and electrodes are not subdivided and form a homogeneous luminous top-emitter field.
